(19) United States
(12) Patent Application Publication
(10) Pub. No.: US 2026/0129435 A1
(43) Pub. Date: May 7, 2026

(54) Shared Secret Key Architecture and Distribution

(71) Applicant: Elliot Eichen, Arlington, MA (US)

(72) Inventor: Elliot Eichen, Arlington, MA (US)

(21) Appl. No.: 18/944,129

(22) Filed: Nov. 12, 2024

Related U.S. Application Data
(60) Provisional application No. 63/548,267, filed on Nov. 13, 2023.

(51) Int. Cl. H04W 12/041; H04W 12/0431; H04W 12/72

(52) U.S. Cl. CPC H04W 12/041; H04W 12/0431; H04W 12/72

(57) ABSTRACT

Methods, apparatuses, computer-readable mediums for storing software, and systems for Shared Secret Key Architecture and Distribution (SSK-AD) are described. SSK-AD leverages an existing network or system that uses shared secret keys (SSKs) to securely distribute new keys based on that network's previously deployed SSKs, its existing SSK ecosystem and architecture, and integration with Trusted Third Party protocols. Examples of such existing network or system that uses SSKs is the 3GPP GSM network or 5G network.

### CROSS-REFERENCE TO RELATED APPLICATIONS

This application is a non-provisional of and claims priority to U.S. Provisional Patent Application No. 63/548,267, filed Nov. 13, 2023, which is hereby incorporated by reference in its entirety.

### BACKGROUND

It is well known that quantum computers with a sufficient number of qubits kept in a coherent state for a sufficient time can break the asymmetric algorithms that form the basis for existing public key cryptography. Even though such quantum computers may not exist today, the threat from quantum computers is immediate because digital communications authenticated and encrypted using existing asymmetric algorithms could be recorded and decrypted in the future, thus providing a wealth of sensitive data.

The response to the threat posed by quantum computers from the cryptographic community has primarily been to create new asymmetric algorithms that are not vulnerable to quantum computing (i.e., algorithms that do not have a periodicity that can be detected by a quantum computer across a coherent quantum state vector made up of the combination of all possible states). Although these Post Quantum Cryptography (PQC) algorithms may turn out to be the best methods to ensure data security over public networks, confidence that they are immune to compromise by quantum computers will take time as PQC algorithms cannot be proved to be secure although they can be proved insecure. Indeed, of the four algorithms chosen by the National Institute of Standards (NIST) in 2022 as a potential PQC standards, one (SIKE) was broken and discarded in 2023, and a successful attack against another of the four algorithms (SPHINCS+) that targeted NIST category V for that algorithm was published in 2022.

An alternative to PQC-particularly for Enterprises or Governments with extremely sensitive data, or IoT devices without the compute power to implement the more complex PQC algorithms (such as low power medical implanted medical devices)—is to use algorithms based on Shared Symmetric Keys (SSKs) such as AES. These algorithms are considered to be immune to compromise by quantum computers although they may need longer key lengths than are currently used. However, a major practical problem limiting the use of Shared Symmetric Keys (SSKs) is how to securely distribute them across a network (e.g., without resorting to some form of physical or out-of-band transfer).

### SUMMARY

This section provides a short summary of certain features discussed in the detailed description. This summary is not an extensive overview and is not intended to identify key or critical elements.

First, the following listing of terms is provided:

Third Generation Partnership Project (3GPP): The standards body that manages the process of creating standards for wireless networks.

5G Authentication and Key Agreement (5G AKA): Protocol used to authenticate endpoint to network and separately to establish keys. 5G also supports EAP (RFC 4187).

5G Core Network (5GC): The core network for a 5G compliant network.

AKMA Anchor Function (AAnF): The 3GPP logical network element that manages the AKMA process. It sits between the UDM/AUSF and the AS.

Authentication and Key Management for Applications (AKMA): The protocol used to extend the 5G AKA protocol to application servers that can be inside or outside of the service provider's domain.

Application Server (AS): server for performing various services or providing various applications.

Authentication Server Function (AUSF): A 3GPP logical network entity that supports the authentication function. When a UE is not roaming, the AUSF communicates directly with a UE. When a UE is roaming, the SEAF sits between the AUSF and the UE.

Network Function (NF): A 3GPP logical entity and that enables web-based APIs for connecting applications to 5GCs.

Global System for Mobile Communications (GSM): The global trade organization made up of wireless carriers, equipment vendors, etc. that represent the “wireless industry”.

Key Distribution Center (KDC): A trusted third party (TTP) system that implements a protocol to distribute keys that allow two entities with a trust relationship to the TTP to mutually authenticate.

International Mobile Subscriber Identity (IMSI): Unique number assigned to each endpoint. Each private key is associated with an IMSI. Pursuant to the 3GPP standard, it contains a network operator, country code, and MDN (mobile device number).

### National Institute of Standards (NIST)

Open Authorization (OAuth): Secure trusted third party open source authentication protocol.

Public Key Infrastructure (PKI): a set of roles, policies, hardware, software and procedures needed to create, manage, distribute, use, store and revoke digital certificates and manage public-key encryption.

Post Quantum Cryptography (PQC): The field of cryptography as it relates to quantum computers. In particular, it often stands for the algorithms (ciphers) that cannot be “broken” using a quantum computer.

Physically Unclonable Function (PUF): Hardware based functionality that produces a unique response to a given input that cannot be copied.

### Shared Secret Key Architecture and Distribution (SSK-AD)

Radio Access Network (RAN): The wide-area wireless network based on towers/base stations and other network components.

Roaming Service Provider (RSP): WAN service provider that UEs can connect to when roaming outside of the service area of their host (home) NSP.

Security Anchor Function (SEAF): The 3GPP logical network entity that supports the authentication function to support UEs that roam into a serving network. Only a subset of the authentication vector and data sent to the AUSF is shared with the SEAF.

Subscriber Identity Module (SIM or USIM): Hardware (integrated circuit) that stores the IMSI and private keys and provides functions in support of authentication, encryption, and integrity. The SIM can also store other subscriber data. It is an example of a Tamper Proof Function (TPF).

Service Provider (SP): includes providers of wireless telecommunication services.

Shared Secret Key (SSK): a private key that is only known by two entities.

Transport Layer Security (TLS): widely used secure protocol that provides authentication, integrity, and privacy. There is a version of TLS that can use a SSK, but it is most often used with a PKI infrastructure.

Tamper Proof Function (TPF): Generally, a hardware device that can store data and execute functions where the data and functions cannot be broken maliciously.

Trusted Third Party (TTP): A system/entity that facilitates interactions between two parties that trust the third party, most often used to enable mutual authentication between two parties.

Trusted Third Party Gateway (TTP-GW): Specific instantiation of a Trusted Third Party integrated into a network architecture with additional capabilities that enable operation within a given network.

Unified Data Management (UDM): Central database (DB) for all subscriber data in a 5G network, with stored procedures that execute functions as requested by logical network elements (network functions). 5G equivalent of the 4G Home Subscriber Service (HSS).

Use Equipment (UE): Subscriber end user devices (smartphones, cell phones, modems, IoT devices, etc.) that connect to a 3GPP defined network.

This invention disclosure on Shared Secret Key Architecture and Distribution (SSK-AD) teaches how an existing network or system that uses SSKs may be used or leveraged to securely distribute new keys based on that network's previously deployed SSKs, its existing SSK ecosystem and architecture, and integration with Trusted Third Party protocols. One such existing network or system that uses SSKs is the Third Generation Partnership Project Global System for Mobile Communications (3GPP GSM network). The 3GPP organization manages and publishes the standards that are adhered to by the vast majority of all mobile carriers, and many non-mobile (wireline) carriers.

This disclosure presents a new set of processes and methods, including software methods performed by computer-readable instructions stored on computer-readable media, as well as new hardware and/or software components. The new processes, methods, software, and hardware required for a particular implementation depends on the particular implementation (e.g., depends on the existing system being used). For example, in the specific case of using a 3GPP compliant 4G, 5G, or 6G network, a new network element called (for the purposes of this disclosure) a Trusted Third Party Gateway or TTP-GW is introduced. Notably, 3GPP standards documents typically define functionality by logical network elements although they may be instantiated as discrete physical network elements, or virtualized within a compute cloud. Likewise, the TTP-GW introduced herein may be a discrete physical network element or virtualized within a compute cloud.

It is interesting to note that the 5G 3GPP community originally proposed using protocols (e.g., TLS and OAuth) based on public key algorithms for external applications. 3GPP release 17 (2022) included new functionality-“Authentication” and Key Management for Applications (AKMA)”-which provided standards for authenticating Application Servers and providing an Application Server proxy function based on the existing (SIM based) SSKs used for authentication. However, this standard does not address: (a) session encryption and thus the ability to prevent sessions from being compromised by quantum computers; (b) modifying the IP routing to prevent the Service Provider (SP) from capturing metadata (for example, the name or IP address of the external application, or the time of the transaction to a given host), or to increase the level of difficulty for the SP to compromise data confidentiality; (c) propagating new keys (some of which are not known by the AKMA service provider and some of which can be stored by the UE and either the TTP-GW or AS); or (d) hiding the subscriber's device identity in any set of new (derived) authentication credentials with a masking protocol (to the contrary, the AKMA specifications were designed to constrain this functionality to remain in the service provider's domain, as hiding the subscriber's IMSI is functionality that is provided during 5G endpoint registration).

The methods, apparatuses, programs, storage media, and systems of SSK-AD may provide one or more of these functions ((a)-(d)). Herein, “SSK-AD” is used to refer to the methods, apparatuses, programs, storage media (e.g., non-transitory computer-readable storage media for storing computer-executable instructions), and/or systems for realizing SSK-AD. Regarding (a) above, addressing encryption enables SSK-AD to solve the issue of attacks by quantum computers without resorting to PQC algorithms. Regarding (b) and (c) above, SSK-AD extends the functionality of AKMA and allows SSK-AD to address applications (such as session border controllers and firewalls) and network architectures (such as peer-to-peer networks) that AKMA cannot. In particular, regarding (c), SSK-AD propagates new keys by repeating the parent (existing SSK)⇒child (new SSK) relationship which in turn allows SSK-AD to move authentication based on SSKs away from the original SSK service provider to another service provider. And, regarding (d) above, SSK-AD's masking protocol supports keeping subscriber meta-data from being revealed to the TTP. SSK-AD thus adds significant capabilities to the 3GPP standards.

While the description in this invention disclosure generally uses GSM networks and existing Trusted Third Party protocols and architectures to illustrate the operation of SSK-AD, multiple types of networks, protocols, and architectures may be used to implement SSK-AD. The main underlying principles are: (i) use networks or systems that employ symmetric key algorithms (also known as ciphers) that exist between members of a given network or system (for example existing SSKs between A⇔C and B⇔C) to share new secret keys (for example between A⇔B) for authentication, integrity, and confidentiality where prior to instantiating SSK-AD, A and B do not share an SSK; (ii) extend the existing architecture to support TTPs outside of the original SPs network that do not require UEs to traverse the SP's network; and (iii) provide a mechanism that enables the process to repeat so that existing SSKs may be used to create new SSKs, and these new SSKs may be used to create additional new SSKs.

These and other features and advantages are disclosed in the accompanying drawings and detailed description below.

### BRIEF DESCRIPTION OF THE DRAWINGS

Some features are shown by way of example, and not by limitation, in the accompanying drawings. In the drawings, like numerals may reference similar elements.

FIGS. 1a-1f illustrate an example system and process in accordance with aspects of this disclosure.

FIG. 2 illustrates an example system and process in accordance with aspects of this disclosure.

FIG. 3 illustrates an example system and process in accordance with aspects of this disclosure, including the aspect of a UE roaming into a visiting service provider's network with authentication credentials provided by the UE's home network.

FIG. 4 illustrates an example system and process in accordance with aspects of this disclosure, including the aspect of moving a session to an alternate endpoint.

FIG. 5 illustrates an example system and process in accordance with aspects of this disclosure, including the aspect of creating an identity or key that is not known by the service provider.

FIG. 6 illustrates an example system and process in accordance with aspects of this disclosure, including the aspect of bypassing the service provider's network.

FIG. 7 shows example hardware elements of an example computing device.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

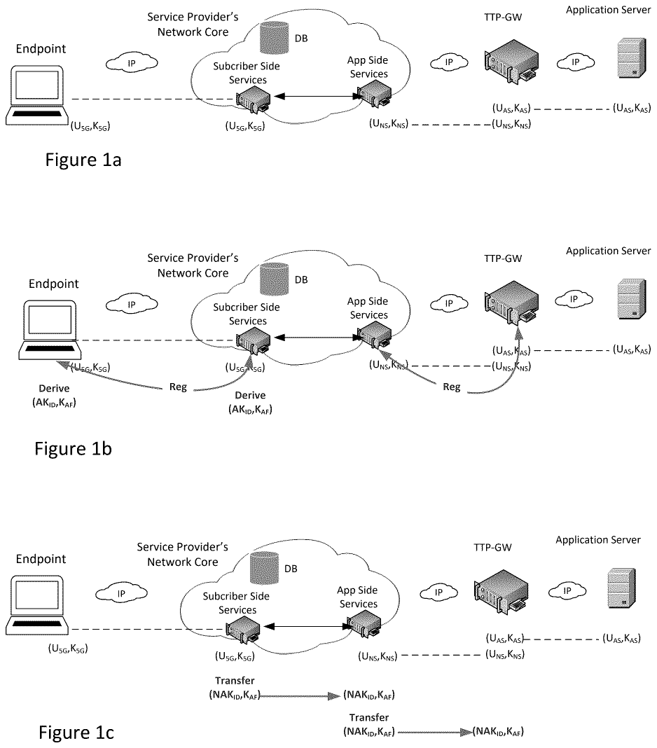

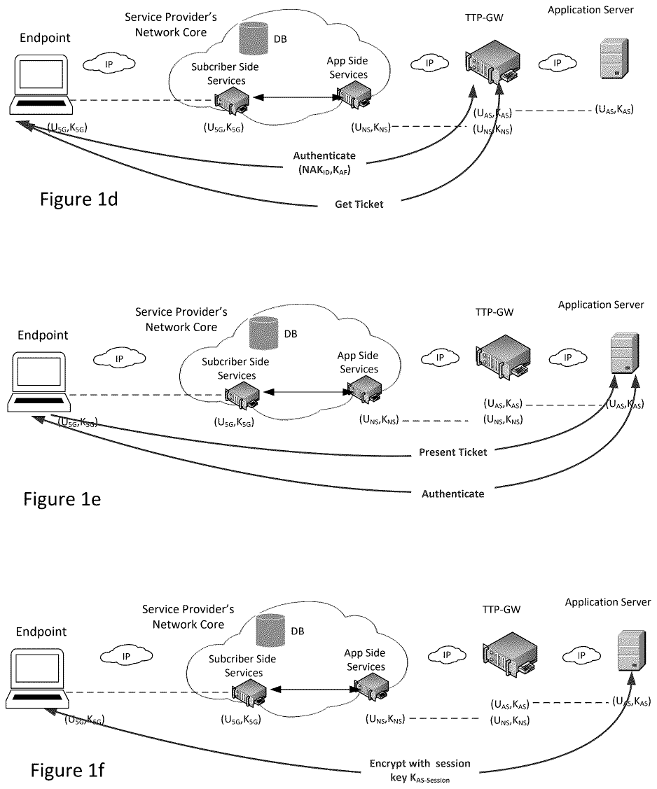

The main underlying principles of SSK-AD (e.g., (i)-(iii) discussed in the summary above) are described with respect to FIGS. 1a-1f.

FIG. 1a illustrates an example system and process in accordance with aspects of this disclosure. More specifically, FIG. 1a shows a generic network architecture in an initial state (e.g., having starting conditions before a secure session is created in accordance with SSK-AD) where the endpoint (e.g., a computing device) shares a set of SSK credentials (e.g., user identifier (e.g., user name and/or number) and key associated with the subscriber (U_{5G}, K_{5G})) with a network subscription service (also referred to as a network subscriber service). In addition, a Trusted Third Party (TTP) (e.g., a TTP-GW) shares a set of SSK credentials with a network application service (and/or the network subscriber service which may be within the same network core as the network application service) (e.g., SSK credentials such as a user identifier and key for the network service (U_{NS}, K_{NS})) and a set of SSK credentials with the Application Server (e.g., SSK credentials such as a user identifier and key for the Application Server (U_{AS}, K_{AS})). There is also a secure connection that cannot be compromised by a quantum computer (secured with a SSK or another methodology like a quantum entangled link) between the network subscription and network application services. In some embodiments, these services (i.e., the network subscription and network application services) may be consolidated into the same service. Also, in some embodiments, the network application service and TTP-GW's service may be consolidated into a single service with multiple identities and SSK credentials. Or, there could also be another a secure (not compromised by quantum computers) link between the TTP-GW and the network services, and/or the link between the TTP-GW and the application server. The application server may provide any service(s), used by the subscriber, that requires a secure (e.g., authenticated, encrypted, and immutable) connection, such as online banking, online shopping, or controlling the Internet of Things (IoT) like controlling thermostats, security systems, etc.

FIG. 1b also illustrates an example system and process in accordance with aspects of this disclosure. The endpoint registers (aka authenticates) with the service provider's network. Similarly, the service provider's network registers (authenticates) with the TTP (e.g., TTP-GW), and also derives a session encryption key from the authentication process and establishes a secure (from all computers including quantum computers) link to pass data through. Although FIG. 1b illustrates the service provider's network authenticating with the TTP, this may occur as part of the initial configuration of the service provider's network or TTP. That is, the service provider's network may have already established (e.g., opened) a secure connection (or channel) to the TTP. In any event, this secure connection between the service provider's network and TTP (e.g., TTP-GW) may provide a channel for registration traffic for separate endpoints (of separate subscribers) to pass through. Indeed, it is contemplated that this secure connection would provide a channel for registration traffic for numerous subscribers. Thus, this secure connection between the service provider's network and TTP does not have to be established for each endpoint or each time a subscriber wants to set up a secure connection. Further, other alternatives (including a quantum entangled link) can be established between the TTP-GW and the service provider's network to create a secure (from all computers including quantum computers) link between the service provider's network and the TTP-GW. The TTP may be external to the service provider's domain, or internal to the service provider's domain. As a result of the registration processes, the endpoint and the subscriber side network service derive a new key (K_{AF}) from other keys used in the registration process, and create a set of credentials (NAK_{ID}, K_{AF}) which may include a new user identifier (e.g., user name) (NAK_{ID}) which may similarly be derived from the previously established credentials (U_{5G}, K_{5G}) using keys from the registration process or some other mechanism.

FIG. 1c also illustrates an example system and process in accordance with aspects of this disclosure. As shown, the credentials (NAK_{ID}, K_{AF}) are transferred across the link from the subscriber side to the application side of the service provider's network using the already established secure (from quantum computers and all other compute devices) link. Alternatively, the subscriber and application side service functions may be consolidated into a single compute environment where all processes are encrypted in such a way that they cannot be broken into. Further, the credentials (NAK_{ID}, K_{AF}) are transferred across the link from the application side of the service provider's network to the TTP (e.g., TTP-GW) using another secure link. This transfer to the TTP may be in response to a request for a secure session from the endpoint to the TTP and another request from the TTP to the service provider's network.

FIG. 1d also illustrates an example system and process in accordance with aspects of this disclosure. Using the TTP relationship (NAK_{ID}, K_{AF}) between the endpoint and the TTP-GW, mutual authentication (e.g., via a Get Ticket Ticket) is performed between the endpoint and the TTP-GW. After authentication, the endpoint requests a “Ticket” from the TTP-GW which contains information (e.g., a TTP authentication vector, such as the vector defined by the Kerberos protocol) that is encrypted with the key (K_{AS}) that exists between the TTP-GW and the application server and that allows the endpoint and the application server to mutually authenticate. The Ticket is generated in real-time by the TTP-GW and transmitted to the endpoint.

FIG. 1e also illustrates an example system and process in accordance with aspects of this disclosure. The ticket delivered to the endpoint in FIG. 1d is presented to the application server. The application server decrypts the Ticket using KAS which enables mutual authentication between the AS and the endpoint.

FIG. 1f also illustrates an example system and process in accordance with aspects of this disclosure. The session key K_{AS-SESSION} is derived by the endpoint (e.g., UE) and the application server for encrypting the link between the application server and the endpoint using a well-known encryption protocol (such as TLS). Thus, a communication session is established on the link between the application server and endpoint in which communications are secure (e.g., authenticated, immutable, and encrypted). This link may include one or more links through one or more networks including the Internet.

SSK-AD may leverage various types of service provider networks or systems. Over the last thirty years (beginning in the early 1990s), 3GPP GSM compliant equipment vendors and service providers have spent billions of dollars creating standards and building and deploying equipment and networks based on those standards. These networks feature a security infrastructure based on SSKs along with a secure ecosystem for out-of-band delivery and use of SSKs. The GSM ecosystem ensures that SSKs are securely delivered to a subscriber's device and securely stored in a Tamper Proof Element (TPF) called the Subscriber Interface Module (SIM, eSIM, or iSIM). SIMs (or eSIMs or iSIMS) are tamper-resistant elements (TREs) that are highly resistant to compromise. Secret keys are never revealed by the SIM or the UDM. The SIM or the UDM only provides decryption or encryption of data passed to it. The GSM ecosystem also ensures that SSKs are securely delivered and stored in the service provider's network (the UDM) along with the SSK to SIM identity's relationship. The SIM's 3GPP identity includes the International Mobile Subscriber Identity (IMSI). Further, the GSM ecosystem ensures that SSKs cannot be maliciously obtained from the network or the subscriber's device (called the User Equipment or UE in 3GPP specifications).

Other existing or future ecosystems may also be potentially leveraged to implement SSK-AD. For example, ecosystems built around embedded security chips in credit cards and the ecosystem used to distribute those credit cards (sometimes called EVM for Europay, Visa, and Mastercard), Fast Identity Online (FIDO) based devices and ecosystems (like that described in “FIDO User Authentication Specifications Overview”, available at https://fidoalliance.org/specifications/), and future ecosystems based on various types of TREs and/or Physically Unclonable Function devices (PUFs) (like those described by Rührmair, Ulrich, in “Secret-free security: a survey and tutorial”, in the Journal of Cryptographic Engineering (2022), available at https://doi.org/10.1007/s13389-021-00283-6) may be leveraged. These technologies and ecosystems have components and procedures that may be reused (or repurposed or leveraged), although they may require modifications to support a SSK-AD system and infrastructure.

While the architectures discussed so far enable connections between clients (end points) and servers (where the servers are systems or applications generally considered as “cloud” components), SSK-AD may also extend to peer-to-peer architectures (like those described by Aberer, Karl and Manfred Hauswirth in “An Overview of Peer-to-Peer Information Systems” in WDAS, vol. 14, no. 2002, and by Fitzek, Frank HP and Hassan Charaf in “Mobile Peer-to-Peer Networks: An Introduction Tutorial Guide”).

SSK-AD may also be applied to an architecture to connect and securely protect two endpoints (without a relationship) that are served by the same carrier even though those endpoints may be roaming (e.g., outside the carrier's network). In practical terms, this could be two smartphones (smartphone A and smartphone B) having the same United States carrier, where smartphone A is in Russia and smartphone B is in Saudi Arabia. In the case of a phone call or a text message from smartphone A to smartphone B where A and B have never connected before, such a call (or text message) could be securely carried over the conventional wireless networks in both countries but would be encrypted and authenticated using SSK-AD so that persons with access to the serving carrier's network in Russia and Saudi Arabia could not breech the call's secure connection.

While many architectural configurations and system options may be used with SSK-AD, examples that describe the operation of SSK-AD may be best described using a 3GPP GSM network, as the specification and operation of these networks are fully documented and available. It is also useful to describe the technical approach based on 3GPP GSM as these networks have the most mature ecosystem and vendor community of all networks that rely on SSKs.

While there are also multiple potential TTP protocols that may be used to implement SSK-AD, examples provided in this application use a Key Distribution Center (KDC) with some modifications to illustrate how the TTP function may be instantiated. An example of a known Key Distribution Center (KDC) is described by Dan Boneh and Victor Shop in “A Graduate Course in Applied Cryptography”, particularly in section 21.12 Key exchange using an online trusted third party, available at https://toc.cryptobook.us/book.pdf. Moreover, the examples herein use Kerberos as the KDC protocol because Kerberos is a common and mature protocol that has been vetted over many years, and is supported as an authentication protocol by many browsers. Kerberos is described by Ricciardi, Fulvio in “Kerberos protocol tutorial,” as published by The National Institute of Nuclear Physics Computing and Network Services, LECCE, Italy (2007), and available at https://www.kerberos.org/software/tutorial.html. However, there are other protocols and architectures that may be used to perform the TTP-GW proxy function.

Also, because there are more potential KDC protocols than Kerberos, the examples in this application use a UE client to support SSK-AD. However, many web browsers (such as Firefox or Edge) support some form of Kerberos. Thus, it should be understood that such browsers, with modifications, could be used as a SSK-AD UE client in some implementations.

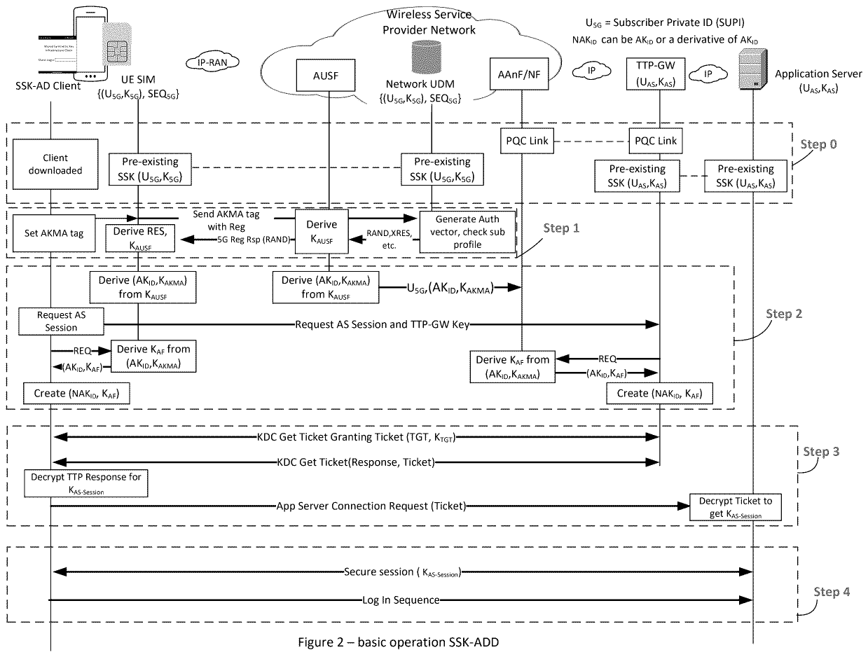

FIG. 2 includes an example ladder diagram and shows an example architecture for carrying out an operation of SSK-AD based on 5G (as described in 3GPP TS 23.501, “System Architecture for the 5G System”).

Step 0: As shown, FIG. 2 includes a step 0, which reflects underlying assumptions or captures one or more configuration steps to effectuate those assumptions. The underlying assumptions or configuration steps include that the service provider's network and subscriber UEs support all the relevant 3GPP standards needed in this embodiment or configuring the service provider's network and subscriber UEs to support all the relevant 3GPP standards. Another assumption or configuration step includes that the subscriber has subscribed to the SSK-AD service provided by the Service Provider (i.e., the Service Provider has enabled the subscriber's ability to use the SSK-AD service and stored this information in the subscriber's service profile), and the subscriber has also downloaded a SSK-AD client onto the UE, or steps of subscribing to the SSK-AD service and downloading a SSK-AD client onto the UE.

Yet another assumption or configuration step captured in step 0 of FIG. 2 includes that the application server (AS) is an existing client to the network's Trusted Third Party Gateway (TTP-GW) with identity and SSK of U_{AS} and K_{AS} or configuring the application server to be an existing client to the TTP-GW with identity and SSK of U_{AS} and K_{AS}. The application server (AS) may or may not be located within the service provider's core, but it should have a secure link to the AAnF/NF (Application and Key Management Anchor Function and Network Repository Function) as described in 3GPP TS 33.535. Here, it is assumed that communication within the service provider's core is secure. Most service provider's currently use some form of PKI to secure links between network elements; they also insulate the core's IP infrastructure from any public network using border elements and non-routable networks. Given the vulnerability of all networks to quantum computers another option within a service provider's core is to use a SSK (or in fact a SSK-AD infrastructure) to secure links between servers rather than PKI. Also, the SSK between the application server and the TTP-GW may be established by adding a modem with a SIM and connectivity to the TTP-GW's service provider as described in this example (steps 0-5), or it could have been established through another route (such as an out-of-band transfer of a shared secret key, or by using a quantum entangled link for connectivity between the TTP-GW and the AAnF/NF).

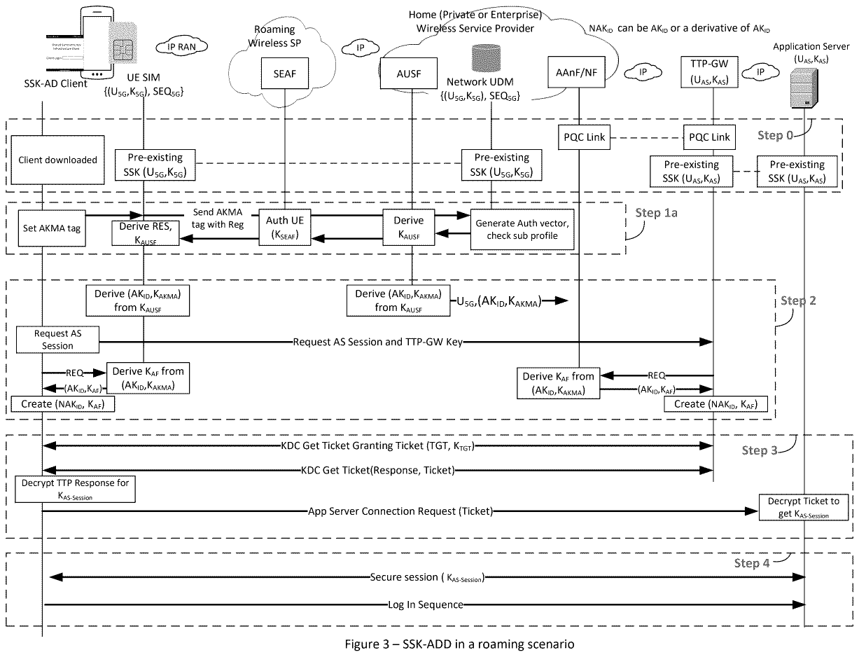

Additionally, another assumption or configuration step captured in step 0 of FIG. 2 includes that the subscriber is not roaming and is connected to the Service Provider's Home Radio Access Network (RAN) or connecting the subscriber to the Service Provider's Home RAN. This assumption simplifies the signaling flow's description and number of steps but is not a requirement. When roaming (i.e., when the endpoint is connected to another Service Provider's network), authentication passes through the serving provider's SEAF (the serving network's Security Anchor Function) in the authentication process; this introduces additional steps in the authentication flow (e.g., step 1a of FIG. 3). Although in this example it is also assumed for simplicity that the service provider operates a wireless RAN, this is also not a requirement as 3GGP specifications may be applied to other types of access networks or to hybrid networks (for example, access through a combination of wide area wireless networks and WiFi or wired ethernet networks).

Finally, it is assumed that the UE has installed an application that is able to use the signaling infrastructure (as described in this invention disclosure) to invoke and process the SSK-AD functionality. For example, this application could be embedded in a web browser or in a separate application. The SSK-AD functionality can be invoked by either the client application triggering a re-registration (step 1), or it can piggy back on top of an existing UE registration (steps 1 and 2) where the client requests a Get Ticket Granting Ticket (step 3).

Step 1: The UE autonomously requests authentication and registration (or re-registration) to a service provider network (e.g., the normal process of turning on a mobile phone), or the subscriber launches the SSK-AD application, which in turn requests an authentication and registration or re-registration to a service provider's network. The authentication and registration process of many steps is described in 3GPP TS 33.501, “Security architecture and producers for 5G.” For simplicity, masking and demasking of the UE's private identity to prevent meta-data from being intercepted by “IMSI catchers”, and many other sub-steps in the authentication and registration process are not shown.

Still referring to step 1, the SSK-AD client may optionally set a tag (or flag), included in an authentication request, to indicate that the subscriber SSK-AD client is requesting connection to an Application Server (AS), therefore requiring the Authentication and Key Management for Applications (AKMA) key (K_{AKMA}) to be derived from the session anchor key (K_{AUSF}). While 3GPP 5G standards require this tag to initiate a AKMA capable session, in some cases (particularly when roaming) it may be preferable not to reveal that the AKMA functionality has been requested (for example, to hide the request for AKMA functionality from the service provider, or from multiple service providers in the case of UE roaming). If the AKMA tag is NOT set, then the network will automatically invoke AKMA functionality (step 2) for all registrations. If the client IS provisioned to use the AKMA tag, the client invokes a registration that includes the AKMA tag in the Registration Request (Set AKMA tag with Regstr Req) in step 1.

When the authentication request reaches the service provider's core, the AUSF forwards the request to the UDM which checks the subscriber's profile, and if the subscriber is authorized to register to the network, creates the home environment authentication vector based on K_{5G} and a Sequence Number (SEQ_{5G}) which is tracked and incremented by both the UE and the UDM. The authentication process in step 1 follows the conventional authentication process as described in 3GPP TS 33.501. The authentication vector, which includes RAND, K_{AUSF}, and XRES, is forwarded to the AUSF. Here: RAND is a random number that changes for each authentication request (a nonce); XRES is the expected response from the UE sent to the AUSF used to validate the UE; and K_{AUSF} is the anchor key that is derived from the permanent key K_{5G} shared by the SP and the UE (it is the root key from which all other keys (including K_{AKMA}) are derived from for this authentication session).

In step 1 of FIG. 2, the AUSF passes the RAND to the UE but retains stateful knowledge of XRES and K_{AUSF}. Using K_{5G} and SEQ_{5G}, the SIM in the subscriber's UE may derive RES and K_{AUSF}. RES is passed back to the AUSF and used to confirm that RES=XRES, and thus K_{5G} is known by the UE's SIM. In this case the authentication process successfully completes.

Step 2: Following successful authentication, the Authentication and Key Management for Applications ID and key (AK_{ID} and K_{AKMA}) are derived from the U_{5G}, K_{AUSF}, and (optionally) other parameters in the authentication vector by the UE (SIM) and the AUSF. The AUSF transfers AK_{ID} and K_{AKMA} to the AKMA Anchor Function (AAnF). The UE (SIM) and the AAnF both derive K_{AF} from AK_{ID} and K_{AKMA}. A request from the client to connect to an AS (Request AS Session) is then sent to the TTP-GW. This triggers the TTP-GW to request credentials (AK_{ID}, K_{AF}) from the AAnF. The TTP-GW creates a new identifier NAK_{ID} (which can be the same as AK_{ID}) and stores new credentials (NAK_{ID}, K_{AF}) in its KDC database. Following transmission of the Request AS Session message, the client requests credentials (AK_{ID}, K_{AF}) from the UE SIM and similarly creates a new identifier NAK_{ID} (which also can be the same as AK_{ID}) that matches the NAK_{ID} created by the TTP-GW.

Step 3: Since the credentials (NAK_{ID}, K_{AF}) are now shared between the UE (SSK-AD client) and TTP-GW, the TTP-GW may act as a conventional KDC. The UE SSK-AD client sends a “Ticket Granting Request” (or “Get Ticket Granting Ticket”) to the TTP-GW/KDC, and the TTP-GW/KDC responds with a Ticket Granting Ticket (TGT). The UE client uses the TGT to request an authentication ticket (the TICKET) from the TTP-GW/KDC. The TTP-GW/KDC sends a Response, including the TICKET, back to the UE. The Client then decrypts at least a portion of the Response (but not the TICKET which may not be readable to the client) to obtain the session key K_{AS-SESSION} and sends the TICKET to the AS. The AS is able to decrypt the TICKET using its KDC key K_{AS}, which allows it to authenticate the client and obtain the same session key (K_{AS-SESSION}).

Step 4: Both the SSK-AD client and the AS can now use the session key from step 3 to create a secure channel between the UE and the AS, or to create a new session key derived from K_{AS-SESSION} and other data. Specifically, K_{AS-SESSION} is used as a session key to encrypt the communication link between the client and the AS. Traditional log-in steps (e.g., username and password) between the UE and the AS may then be used to validate the subscriber.

The result of steps 0-4 is a secure (e.g., authenticated, immutable, and encrypted) session between the subscriber's UE and AS that did not use public key cryptography at all, and thus is resistant to compromise by quantum computers. Notable, before starting the SSK-AD client to connect to an AS, the UE, and the AS did not share a private key.

Basic Operation of SSK-AD where the UE is roaming outside of its home network (FIG. 3): In some cases, it may be advantageous for the UE to roam outside of its home network and, when doing so, hide all AKMA identities and keys from the roaming service provider (RSP). 3GPP TS 33.535 provides a roaming architecture that introduces a new logical network element—the Security Anchor Function (SEAF)—which enables the RSP to proxy the authentication process on behalf of the home network service provider without allowing the RSP to decrypt K_{AUSF} and thus compromise the AKMA functionality. In the case of roaming, the home (or private) network provider passes KSEAF to the SEAF which enables the SEAF to register the UE to the roaming network without revealing K_{AUSF}. This is illustrated in Step 1a of FIG. 3.

Moving Sessions to Alternate Endpoints: In some cases, it may be advantageous to move the secure communication session from the UE to another endpoint; a typical example of this might be a subscriber's PC or a tablet without a wireless cellular modem (e.g., without a 4G, 5G, or 6G modem). In this way, the unique SIM of a UE may be leveraged to create a secure (e.g., authenticated, encrypted, and immutable) communication session between another endpoint (e.g., a computer) and an application server.

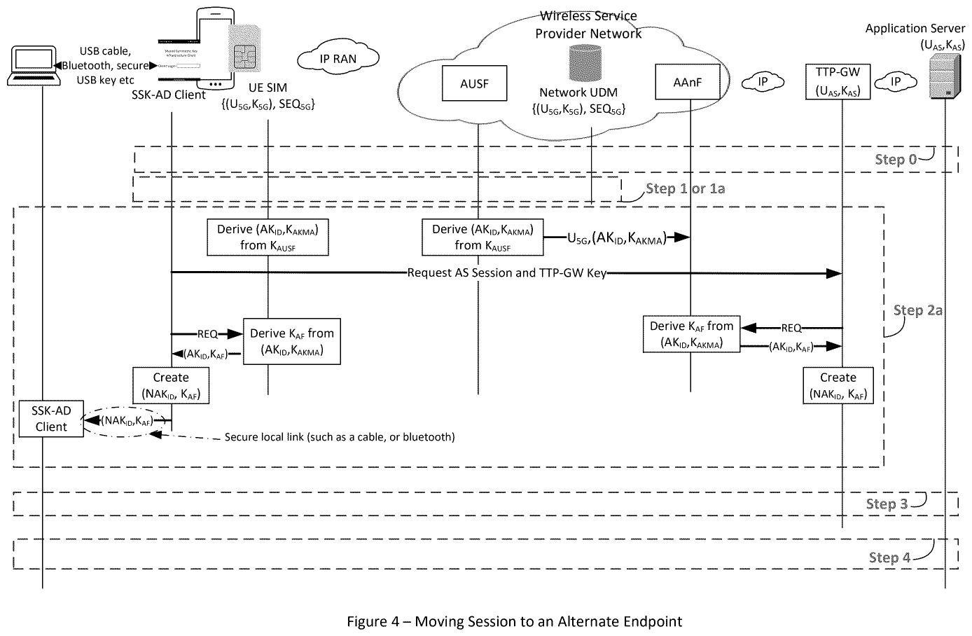

While there are multiple ways to architect moving the secure session to another endpoint, one way (shown in FIG. 4) is to move TTP-GW UE credentials (NAK_{ID}, K_{AF}) from the SSK-AD Client on the UE to a SSK-AD Client on the PC over a secure local link (such as a USB cable, a Bluetooth peer-to-per connection, etc.). This is illustrated in Step 2a of FIG. 4. Additionally, or alternatively, these credentials may be burned to a hardware encryption device (e.g., flash drive) and loaded onto the alternate endpoint (e.g., PC). This may be accomplished using a new application, routine, or module of the SSK-AD client that enables a one-time burn of the credentials and then erases them from any storage. On the alternate endpoint side (e.g., PC side), another new module (e.g., web browser plug-in) may be provided for storing (e.g., temporarily, which may be defined by a timing parameter passed along with the credentials) the credentials. Also, if the relationship between the AS and the PC (or tablet, etc.) is to be maintained (e.g., permanent such as in cases of permanently bypassing the service provider's network), the credentials should be securely stored in some form of TPF on the PC.

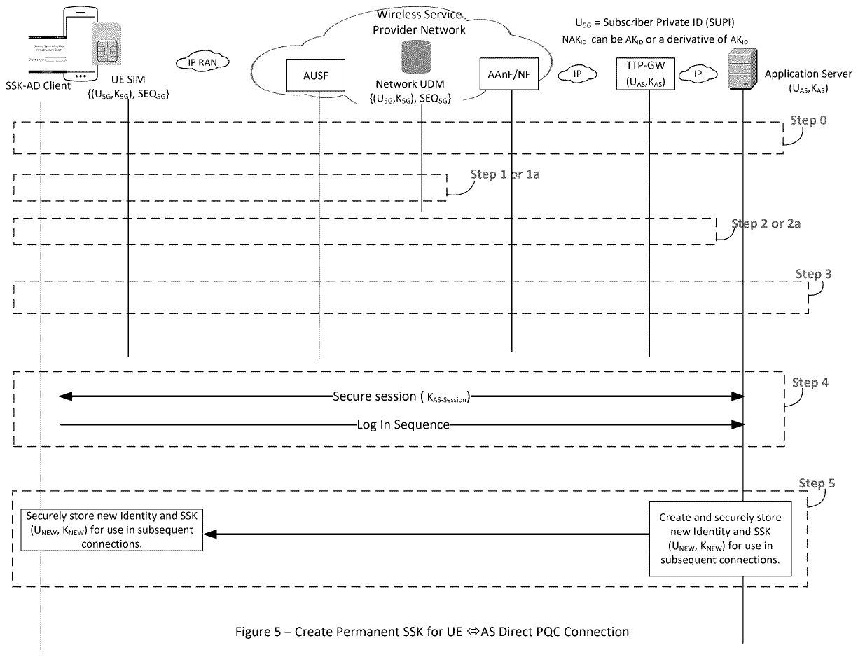

Further, in some cases, it may be advantageous for either or both of the UE and TTP-GW to forget (delete) the credentials (NAK_{ID}, K_{AF}) shared by the UE and the TTP-GW, thus forcing the UE to repeat steps 0-4 for each connection to the same application server or to different application servers. This deletion may be performed by the SSK-AD client and/or TTP-GW periodically. Or, the SSK-AD client may generate and associate a timestamp with the credentials and delete the credentials upon determining that the credentials have exceeded an expiration period based on the time stamp. The expiration period's length may differ for different services (which may be provided by different application servers). The length of the expiration period may be determined based on one or more settings that are set by the user of the UE and/or the application server to indicate a risk tolerance (e.g., if risk tolerance is relatively high, the expiration period may be relatively long) or to indicate an estimated amount of usage of the service (e.g., if the expected usage of a service is relatively high, the expiration period may be relatively long). In other cases (for example, when a subscriber is a heavy user of this service), it may be advantageous to retain a permanent relationship between UE (or another user endpoint if the session was moved to it as explained with respect to FIG. 4) and the TTP-GW so that new connections between the UE (or other endpoint) and any AS within the TTP-GW's domain only have to traverse steps 3 and 4. Similarly, it may be advantageous to retain a permanent relationship between UE (or other endpoint) and a specific AS (as illustrated in FIG. 5) in which a permanent SSK is retained by both the UE and the AS. In particular, FIG. 5 shows an additional step (Step 5) in which both the UE (or other endpoint) and AS create and securely store a new identity and SSK (e.g., (U_{NEW}, K_{NEW}) for use in subsequent connections.

Bypassing the Service Provider's Network: In some cases, a service provider may have access to SSK-AD metadata (such as when connection requests are made). In these cases, it may be advantageous to restrict the service provider from having access to this metadata.

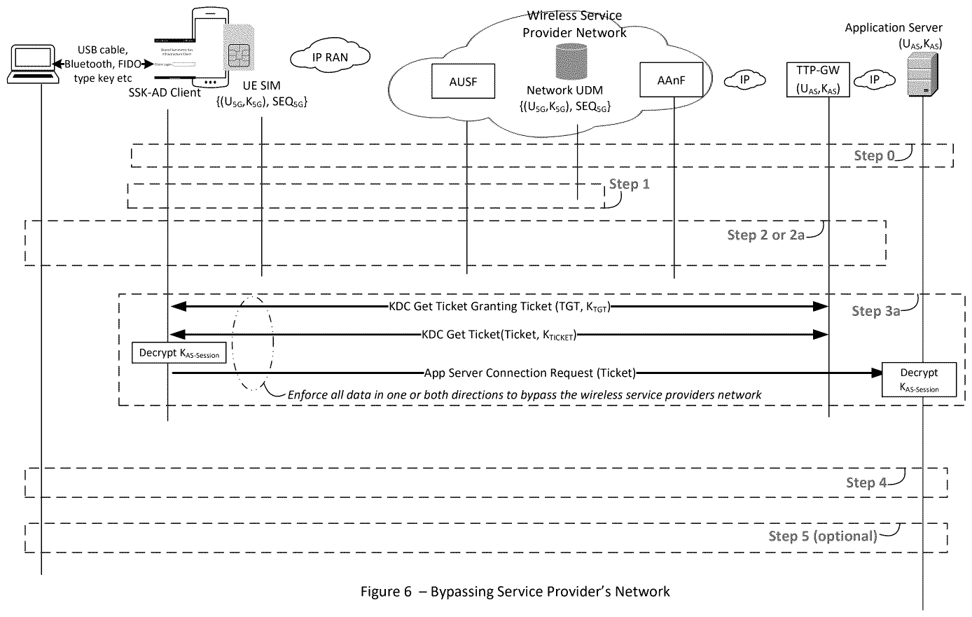

These concerns may be addressed by bypassing the service provider's network once K_{AKMA} has been received by the UE and K_{AF} has been received by the TTP-GW. Such bypassing can be accomplished in some cases by enforcing a particular network path that bypasses any given service provider network at the transport layer of the given network element, as shown in FIG. 6. In particular, Step 3a shows the UE and/or AS enforcing a rule that all data in one or both directions bypass the wireless service provider's network. Accordingly, the Ticket granting process may be accomplished by bypassing the wireless service provider's network. Bypassing the service provider's network may be accomplished by having the SSK-AD client replace the UE to RAN connection with network connectivity that bypasses the service provider's network (for example, using a WiFi local area network connected to a wired broadband provider, or establishing a VPN between the UE and the TTP-GW). Policing a bi-directional bypassed network connection may be enforced by communication between the UE and TTP-GW. Although FIG. 6 shows step 3a being partially performed by the SSK-AD client on the UE, it should be understood that the same processes would be performed by the alternate endpoint (e.g., PC) if the session was moved to the alternate endpoint in Step 2a as discussed above.

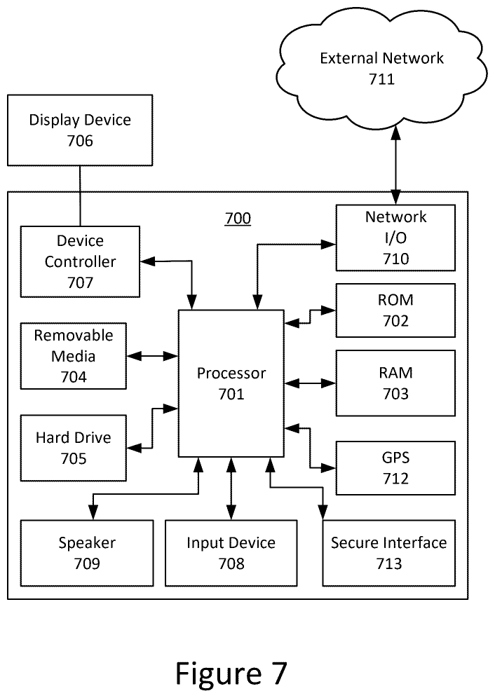

FIG. 7 shows hardware elements of a computing device 700 that may be used to implement any of the computing devices described herein (e.g., SSK-AD client or TTP-GW). The computing device 700 may comprise one or more processors 701, which may execute instructions of a computer program to perform any of the functions described herein. The instructions may be stored in a read-only memory (ROM) 702, random access memory (RAM) 703, removable media 704 (e.g., a USB drive, a compact disk (CD), a digital versatile disk (DVD)), and/or in any other type of computer-readable medium or memory. Instructions may also be stored in an attached (or internal) hard drive 705 or other types of storage media. The computing device 700 may comprise one or more output devices, such as a display device 706 (e.g., a touchscreen, an external monitor and/or other external or internal display device) and a speaker 709, and may comprise one or more output device controllers 707, such as a video processor. One or more user input devices 708 may comprise a remote control, a keyboard, a mouse, a touch screen (which may be integrated with the display device 706), microphone, etc. The computing device 700 may also comprise one or more wired or wireless network interfaces, such as a network input/output (I/O) 710 (e.g., a network card) to communicate with an external network 711 (e.g., the Internet or another WAN, or a LAN). Through the network I/O the computing device 700 may receive various information (e.g., keys and authentication information discussed herein). The network I/O interface 710 may comprise a modem configured to communicate via the external network 711. The external network 711 may comprise the communication links discussed above, a RAN, a network provider's wireless, coaxial, fiber, or hybrid fiber/coaxial distribution system, or any other desired network. The computing device 700 may also comprise a location-detecting device, such as a global positioning system (GPS) microprocessor 712, which may be configured to receive and process global positioning signals and determine a geographic position of the computing device 700.

The computing device 700 may also include a secure interface 713 for securely communicating data (e.g., authentication information, credentials, keys, etc.) with another device via a secure link as discussed herein.

Although FIG. 7 shows an example hardware configuration, one or more of the elements of the computing device 700 may be implemented as software or a combination of hardware and software. Modifications may be made to add, remove, combine, divide, etc. components of the computing device 700. Additionally, the elements shown in FIG. 7 may be implemented using basic computing devices and components that have been configured to perform operations such as are described herein. For example, a memory of the computing device 700 may store computer-executable instructions that, when executed by the processor 701 and/or one or more other processors of the computing device 700, cause the computing device 700 to perform one, some, or all of the operations described herein, such as deriving keys, creating credentials, generating requests or tickets, performing authentication, etc. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to deriving the keys and other operations described herein. An IC may perform some operations based on execution of programming instructions read from ROM or RAM, with other operations hardwired into gates or other logic.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

For example, steps of key derivation described herein are not limited to a particular derivation procedure. Key derivation—where a new key is derived from an existing key—is used extensively in many cryptographic settings (including environments described in this disclosure) and is described in many textbooks on cryptography (such as in chapter 8.10 of “A Graduate Course in Applied Cryptography” by Boneh and Shoup). In practice, a key derivation function is based on well-known ciphers such as SHA256 or HKDF. An important feature of key derivation functions is to prevent the old (input key) from being computed from the new key.

Further, the following paragraphs set forth numbered clauses to describe how various features are combinable and yield embodiments of various scopes. These clauses are not to be interpreted as limiting.

Clause 1: A method, comprising: (1) generating, by a first computing device (e.g., a network end point such as a mobile phone, UE, etc.), new credentials comprising a new user identifier (AK_{ID} or NAK_{ID}) and a new key (e.g., K_{AF}) based on (e.g., derived from) an existing shared secret key (e.g., the key K_{5G} stored in a SIM for supporting 5G wireless communication service) that is shared with a service provider (e.g., a company providing a communication service, such as 5G service); (2) performing authentication, between the first computing device or a second computing device (e.g., another endpoint like a PC) and a third party device (e.g., TTP-GW), using the new credentials (e.g., (NAK_{ID}, K_{AF})) to obtain a response (e.g., from the TTP-GW) comprising a ticket (e.g., Kerberos ticket); (3) determining a session key (e.g., K_{AS-SESSION}) based on the response; (4) sending, by the first computing device or the second computing device to an application server (e.g., AS of a bank for providing online banking), the ticket; and (5) establishing, using the session key, a secure (e.g., authenticated, encrypted, and immutable) session between the first computing device or the second computing device and the application server.

Clause 2: The method described in Clause 1, wherein an algorithm is used to derive the new key from the existing shared secret key. The algorithm may be any algorithm that prevents the existing shared secret key (e.g., K_{5G}) from being obtained from the new key (e.g., K_{AF}). An example algorithm is SHA256.

Clause 3: The method described in Clause 1 or Clause 2, wherein the existing shared secret key and/or the new key are of sufficient length and/or complexity (e.g., use a combination of letters, numbers, and/or other characters) such that these keys are computationally undiscoverable by quantum computers in a reasonable length of time. For example, the keys are configured such that it would take a quantum or conventional computer so long to discover these keys that the information concealed by the key would be useless by the time such a discovery was made (e.g., longer than any person's lifetime to discover information about that person, like that person's date of birth, social security number, bank account information, etc.). From a computer science perspective, algorithms that can solve a problem (i.e. discovering a key) in a “reasonable” (i.e. finite) amount of time are called polynomial-time algorithms, while problems that require searching for a solution from all possible solutions are called NP-complete problems that require on the order of 2˜ steps where N is the length of the key.

Clause 4: The method described in any one of Clauses 1-3, wherein the existing shared secret key (e.g., K_{5G}) has been previously distributed to the first computing device (e.g., a network end point such as a mobile phone, UE, etc.) or between the first computing device and the service provider (e.g., a company providing a communication service, such as 5G service) in such a manner (e.g., hand delivered) that the shared secret key is only known to the computing device and the service provider and/or is computationally undiscoverable.

Clause 5: The method described in any one of Clauses 1-4, wherein the third party device (e.g., TTP-GW) and the application server (e.g., AS) each store, or otherwise have, a key (e.g., a shared secret key, like K_{AS}) prior to the first computing device or the second computing device sending the ticket to the application server. For example, the third party device and the application server may have obtained this key in such a manner that it is only known by the third party device and the application server. Also, in some cases, the third party device and the application server may have obtained this key before the first computing device generates the new key (e.g., K_{AF}).

Clause 6: The method described in any one of Clauses 1-5, wherein the third party device has established a secure (e.g., authenticated, encrypted, and immutable) communication link (e.g., that is immune from compromise by quantum computers) with a service provider device of the service provider. For example, this link may use a Post Quantum Cryptography algorithm to encrypt communications across it.

Clause 7: The method described in any one of Clauses 1-6, wherein the first computing device generates the new user identifier (NAK_{ID}) and/or the new key (e.g., K_{AF}) based on the existing shared secret key (e.g., K_{5G}) and data received from a server provider device of the service provider. For example, the first computing device derives the new key from the existing shared secret key and data received in a registration response from the server provider device (e.g., a device providing the AUSF).

Clause 8: The method described in any one of Clauses 1-7, wherein a service provider device of the service provider generates a new user identifier (AK_{ID}) and/or the new key (e.g., K_{AF}) based on the existing shared secret key (e.g., K_{5G}). The service provider device of the service provider may also send its new user identifier (AK_{ID}) and/or the new key (e.g., K_{AF}) to the third party device. That is, the third party device may receive the new user identifier (AK_{ID}) and/or the new key (e.g., K_{AF}) from the service provider device (e.g., over a secure communication link, such as a link that uses a Post Quantum Cryptography algorithm to encrypt communications across it).

Clause 9: The method described in any one of Clauses 1-8, wherein the first computing device and/or third party device generate or create a second new user identifier (NAK_{ID}) and store the second new user identifier (NAK_{ID}) in association with the new key (K_{AF}). In some cases, the second new user identifier may have the same value as the first new user identifier (AK_{ID}).

Clause 10: The method described in any one of Clauses 1-9, wherein the first computing device or the second computing device requests and receives the ticket (and/or additional tickets) from the third party device using a key distribution protocol (e.g., Kerberos). In such cases, the third party device may function as a key distribution center (KDC).

Clause 11: The method described in any one of Clauses 1-10, wherein the ticket enables the first computing device or the second computing device and the application server to mutually authenticate and/or wherein the secure session between the first computing device or the second computing device and the application server uses a symmetric algorithm for encrypting communications.

Clause 12: The method described in any one of Clauses 1-11, further comprising sending, by the first computing device, a registration request with a tag indicating that the first computing device is requesting a connection to the application server.

Clause 13: The method described in any one of Clauses 1-12, wherein the generating the new credentials is responsive to sending a registration request (e.g., for registering with a wireless service provider) and receiving a registration response.

Clause 14: The method described in any one of Clauses 1-13, wherein the generating the new credentials is responsive to sending, to the third party device, a request for the secure session between the first computing device or the second computing device and the application server.

Clause 15: The method described in any one of Clauses 1-14, further comprising sending, from a client operating on the first computing device to a SIM of the first computing device, a request, wherein the generating the new credentials is performed by the client and is responsive to sending the request to the SIM.

Clause 16: The method described in any one of Clauses 1-15, further comprising sending, from the first computing device (e.g., UE) to the second computing device (e.g., PC), the new credentials.

Clause 17: The method described in any one of Clauses 1-16, further comprising creating and storing, by the first computing device or the second computing device, second new credentials (U_{NEW}, K_{NEW}) for use by the first computing device or the second computing device in communicating with the application server after the secure session ends.

Clause 18: The method described in any one of Clauses 1-17, wherein the sending the ticket includes sending the ticket through a path that bypasses a network of the service provider.

Clause 19: An apparatus (e.g., computing device) configured to perform the method described in any one of Clauses 1-18. The apparatus may comprise one or more processors and memory (e.g., RAM, ROM, etc.) storing instructions that, when executed by the one or more processors, cause the apparatus to perform the method described in any one of Clauses 1-18.

Clause 20: A system comprising one or more computing devices configured to perform the method described in any one of Clauses 1-18. Each of the one or more computing devices may comprise one or more processors. For example, the system may comprise the first computing device, second computing device, service provider device, third party device, and/or application server described in any one of Clauses 1-18. The computing device may comprise a UE (e.g., mobile phone). The third party device may comprise a network element outside of a domain of the service provider. The third party device may also be separate and/or remote from the application server and/or controlled by a different entity that controls the application server.

Clause 21: One or more non-transitory computer readable media storing instructions (e.g., computer-executable instructions like software, a computer program, or a computer application) that, when executed (e.g., by one or more processors), cause performance of the method described in any one of Clauses 1-18.

Clause 22: A first computing device (e.g., endpoint) outside of a service provider network (e.g., not owned by the service provider), the first computing device comprising a module for performing authentication with a second computing device (e.g., TTP-GW or AS) having a shared secret key with the service provider network.

Clause 23: A computing device (e.g., endpoint) comprising a first module storing a shared secret key that is shared with a service provider (e.g., a wireless network provider device); and a second module for deriving a new key based on the shared secret key.

Clause 24: The computing device described in Clause 23, wherein the second module is configured to transfer the new key to another computing device and delete the key in response to successful completion of the transfer.

1. A method, comprising:
generating, by a first computing device, new credentials comprising a new user identifier and a new key based on an existing shared secret key that is shared with a service provider;
performing authentication, between the first computing device or a second computing device and a third party device, using the new credentials to obtain a response from the third party device, the response comprising a ticket;
determining a session key based on the response;
sending, by the first computing device or the second computing device to an application server, the ticket; and
establishing, using the session key, a secure session between the first computing device or the second computing device and the application server.

2. The method of claim 1, wherein an algorithm is used to derive the new key from the existing shared secret key and the algorithm prevents the existing shared secret key from being obtained from the new key.

3. The method of claim 1, wherein the new key is computationally undiscoverable by quantum computers.

4. The method of claim 1, wherein the third party device and the application server each store a second shared secret key prior to the first computing device or the second computing device sending the ticket to the application server.

5. The method of claim 1, wherein the third party device has established a secure communication link with a service provider device of the service provider.

6. The method of claim 1, comprising:
generating the new user identifier or the new key based on the existing shared secret key and data received from a server provider device of the service provider.

7. The method of claim 1, comprising:
generating and storing a second new user identifier in association with the new key.

8. The method of claim 1, comprising:
requesting the ticket; and
receiving, from the third party device, the ticket, wherein the ticket enables authentication with the application server.

9. The method of claim 1, comprising:
sending a registration request with a tag indicating that the first computing device is requesting a connection to the application server.

10. The method of claim 1, wherein the generating the new credentials is responsive to sending a registration request and receiving a registration response.

11. The method of claim 1, wherein the generating the new credentials is responsive to sending, to the third party device, a request for the secure session between the first computing device or the second computing device and the application server.

12. The method of claim 1, comprising:
sending, to a subscriber identity module of the first computing device, a request, wherein the generating the new credentials is responsive to sending the request to the subscriber identity module.

13. The method of claim 1, comprising:
sending, from the first computing device to the second computing device, the new credentials.

14. The method of claim 1, comprising:
creating and storing second new credentials for use by the first computing device or the second computing device in communicating with the application server after the secure session ends.

15. The method of claim 1, wherein the sending the ticket comprises sending the ticket through a path that bypasses a network of the service provider.

16. An apparatus comprising:
one or more processors; and
memory storing instructions that, when executed by the one or more processors, cause the apparatus to:
generate new credentials comprising a new user identifier and a new key based on an existing shared secret key that is shared with a service provider;
perform authentication, between the apparatus and a third party device, using the new credentials to obtain a response from the third party device, the response comprising a ticket;
determine a session key based on the response;
send, to an application server, the ticket; and
establish, using the session key, a secure session between the apparatus and the application server.

17. The apparatus of claim 16, wherein generation of the new credentials is responsive to the apparatus sending a registration request and receiving a registration response.

18. A system comprising:
a computing device configured to:
generate new credentials comprising a new user identifier and a new key based on an existing shared secret key that is shared with a service provider;
perform authentication, between the computing device and a third party device, using the new credentials to obtain a response from the third party device, the response comprising a ticket;
determine a session key based on the response;
send, to an application server, the ticket; and
establish, using the session key, a secure session between the computing device and the application server; and
the third party device configured to communicate with the service provider, wherein the third party device is outside of a domain of the service provider.

19. The system of claim 18, further comprising:
the application server configured to store a second shared secret key that is shared with the third party device.

20. The system of claim 18, wherein the third party device is configured to:
generate a second new user identifier matching the new user identifier;
generate a second new key matching the new key; and
generate the ticket.
